(19) United States
(12) Patent Application Publication
(10) Pub. No.: US 2012/0305670 A1
(43) Pub. Date: Dec. 6, 2012

(54) SYSTEM FOR CONDITIONING FLOW THROUGH A COMBUSTOR

(75) Inventors: Luis Manuel Flamand, Simpsonville, SC (US); Kwanwoo Kim, Cincinnati, OH (US); Patrick Benedict Melton, Horse Shoe, NC (US)

(73) Assignee: GENERAL ELECTRIC COMPANY, Schenectady, NY (US)

(21) Appl. No.: 13/153,531

(22) Filed: Jun. 6, 2011

(51) Int. Cl. B05B 1/26

(52) U.S. Cl. 239/518

(57) ABSTRACT

A system for conditioning flow through a combustor includes a nozzle, and a shroud circumferentially surrounds at least a portion of the nozzle. The shroud defines an upstream opening, and a plurality of vanes extends radially inward from the shroud. A circumferential slot extends through the shroud between the upstream opening and the plurality of vanes.

### FIELD OF THE INVENTION

The present invention generally involves a system for conditioning flow through a combustor. In particular embodiments of the present invention, flow may be diverted through a circumferential slot in one or more nozzles arranged in the combustor to enhance the distribution of a compressed working fluid through the combustor.

### BACKGROUND OF THE INVENTION

Combustors are commonly used in industrial and power generation operations to ignite fuel to produce combustion gases having a high temperature and pressure. For example, gas turbines typically include one or more combustors to generate power or thrust. A typical gas turbine used to generate electrical power includes an axial compressor at the front, one or more combustors around the middle, and a turbine at the rear. Ambient air may be supplied to the compressor, and rotating blades and stationary vanes in the compressor progressively impart kinetic energy to the working fluid (air) to produce a compressed working fluid at a highly energized state. The compressed working fluid exits the compressor and flows through one or more nozzles into a combustion chamber in each combustor where the compressed working fluid mixes with fuel and ignites to generate combustion gases having a high temperature and pressure. The combustion gases expand in the turbine to produce work. For example, expansion of the combustion gases in the turbine may rotate a shaft connected to a generator to produce electricity.

During normal combustor operations, a combustion flame exists downstream from the nozzles, typically in the combustion chamber at the exit of the nozzles. Occasionally, however, “flame holding” may occur in which a combustion flame exists upstream from the combustion chamber inside one or more nozzles. For example, conditions may exist in which a combustion flame exists near a fuel port in the nozzles or near an area of low flow in the nozzles. Nozzles are typically not designed to withstand the high temperatures created by a flame holding event which may therefore cause severe damage to a nozzle in a relatively short amount of time.

Various methods are known in the art for preventing or reducing the occurrence of flame holding. For example, the tortuous flow path of the compressed working fluid through the combustor may produce excessive pressure loss and/or create regions of uneven flow through the combustor and/or nozzles. Each of these effects reduces the efficiency of the combustor and increases the chance of flame holding occurring at the low flow regions. Therefore, a system for conditioning the flow of the compressed working fluid through the combustor and/or nozzles that reduces the pressure loss across the combustor and/or the regions of uneven flow through the combustor and/or nozzles would be useful.

### BRIEF DESCRIPTION OF THE INVENTION

Aspects and advantages of the invention are set forth below in the following description, or may be obvious from the description, or may be learned through practice of the invention.

One embodiment of the present invention is a system for conditioning flow through a combustor. The system includes a plurality of nozzles, and a shroud circumferentially surrounds at least a portion of each nozzle. Each shroud defines an upstream opening for each nozzle. A circumferential slot extends through at least one shroud downstream from the upstream opening.

Another embodiment of the present invention is a system for conditioning flow through a combustor that includes a plurality of nozzles, and a shroud circumferentially surrounds at least a portion of each nozzle. A shield circumferentially surrounds the plurality of nozzles, and a flow path extends through the shield and through at least one shroud.

In yet another embodiment of the present invention, a system for conditioning flow through a combustor includes a nozzle, and a shroud circumferentially surrounds at least a portion of the nozzle. The shroud defines an upstream opening, and a plurality of vanes extends radially inward from the shroud. A circumferential slot extends through the shroud between the upstream opening and the plurality of vanes.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a simplified cross-section of a portion of a combustor according to one embodiment of the present invention; and

FIG. 2 is perspective view of a shroud shown in FIG. 1 according to one embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention include a system for conditioning flow through a combustor. In particular, various embodiments of the present invention may reduce recirculation zones of compressed working fluid flowing through the combustor. Although exemplary embodiments of the present invention will be described generally in the context of a combustor incorporated into a gas turbine for purposes of illustration, one of ordinary skill in the art will readily appreciate that embodiments of the present invention may be applied to any combustor and are not limited to a gas turbine combustor unless specifically recited in the claims.

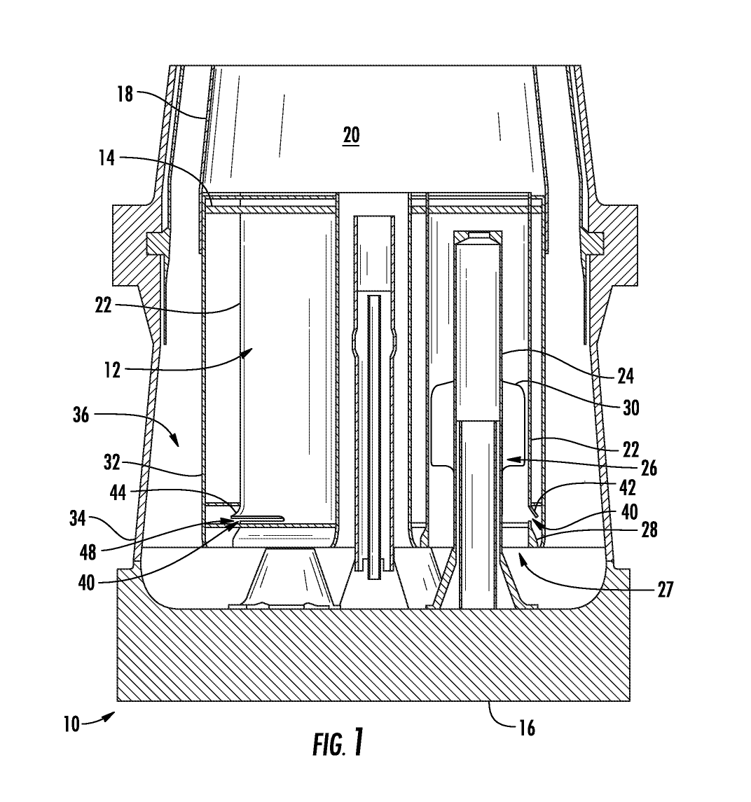

FIG. 1 provides a simplified cross-section of a portion of a combustor 10, such as may be included in a gas turbine, according to one embodiment of the present invention. The combustor 10 may include one or more nozzles 12 radially arranged between a cap 14 and an end cover 16. The cap 14 and a liner 18 generally surround and define a combustion chamber 20 located downstream from the nozzles 12. As used herein, the terms “upstream” and “downstream” refer to the relative location of components in a fluid pathway. For example, component A is upstream from component B if a fluid flows from component A to component B. Conversely, component B is downstream from component A if component B receives a fluid flow from component A.

Each nozzle 12 may generally include a shroud 22 that circumferentially surrounds at least a portion of a center body 24 to define an annular passage 26 having an upstream opening 27 between the shroud 22 and the center body 24. The center body 24 generally extends axially from the end cover 16 toward the cap 14 to provide fluid communication for fuel to flow from the end cover 16, through the center body 24, and into the combustion chamber 20. The upstream opening 27 of the shroud 22 may include a bellmouth opening 28 to enhance the radial distribution of the compressed working fluid flowing through the annular passage 26 between the shroud 22 and the center body 24. In addition, one or more vanes 30 may extend radially inward from one or more shrouds 22 to the center body 24 to impart a tangential swirl to the compressed working fluid to enhance mixing with the fuel prior to combustion.

As shown in FIG. 1, a cap shield 32 may circumferentially surround the nozzles 12 between the cap 14 and the end cover 16, and a casing 34 may surround the liner 18 and cap shield 32 to define an axis-symmetric annular passage 36 that circumferentially surrounds the combustion chamber 20 and nozzles 12. The compressed working fluid may flow through the annular passage 36 to provide impingement and/or convective cooling to the liner 18 and/or cap shield 32. When the compressed working fluid reaches the end cover 16, the compressed working fluid reverses direction to flow through the one or more nozzles 12 where it mixes with fuel before igniting in the combustion chamber 20 to produce combustion gases having a high temperature and pressure.

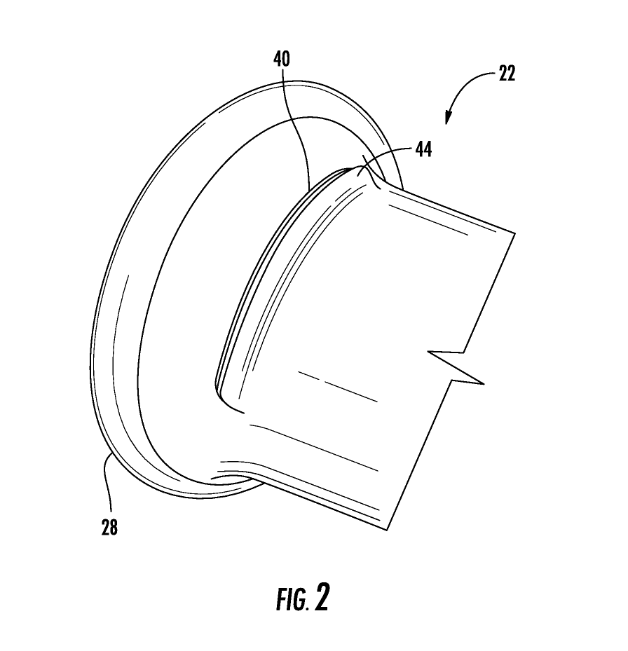

FIG. 2 provides a perspective view of the shroud 22 shown in FIG. 1 according to one embodiment of the present invention. As shown in FIGS. 1 and 2, a circumferential slot 40 extends through one or more shrouds 22 in the combustor 10. As shown in FIG. 1, the circumferential slot 40 may be located downstream from the upstream opening 37 and upstream from the vanes 30, if present. The circumferential slot 40 may extend around all or only a portion of the shroud 22. For example, as shown most clearly in FIG. 2, the circumferential slot 40 may extend around less than approximately 50 percent of the shroud 22. In particular embodiments, the circumferential slot 40 may be located proximate to the radially outward portion of each shroud 22 present in the combustor 10, while in other particular embodiments, the circumferential slot 40 may be located at various radially inward or outward locations of particular shrouds 22 as desired to equalize flow through the combustor 10.

As further shown in FIGS. 1 and 2, the circumferential slot 40 may further include a substantially straight tab 42 or a partially curved tab 44. The straight or curved tabs 42, 44 may be connected to the circumferential slot 40 and may extend radially outward from the circumferential slot 40. In addition, the cap shield 32 may include an opening 46 radially aligned with the circumferential slot 40 to define a flow path 48 through both the cap shield 32 and the shroud 22.

The various combinations of the circumferential slot 40, flow path 48, and/or tabs 42, 44 condition flow through the combustor 10 to reduce the pressure losses and low flow regions associated with the flow path of the compressed working fluid. Specifically, at least a portion of the compressed working fluid flowing through the annular passage 36 may be diverted through the opening 46 and/or through the circumferential slot 40 into the nozzle 12 to reduce recirculation zones inside the combustor 10. As a result, it is anticipated that each nozzle 12 will receive a more uniform distribution of compressed working fluid, by volume and velocity, which in turn enhances the efficiency and flame holding margin for each nozzle 12.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal languages of the claims.

What is claimed is:

1. A system for conditioning flow through a combustor, comprising:
a. a plurality of nozzles;
b. a shroud circumferentially surrounding at least a portion of each nozzle, wherein each shroud defines an upstream opening for each nozzle; and
c. a circumferential slot extending through at least one shroud downstream from the upstream opening.

2. The system as in claim 1, wherein the upstream opening comprises a bellmouth shape.

3. The system as in claim 1, further comprising a plurality of vanes extending radially inward from the at least one shroud downstream from the circumferential slot.

4. The system as in claim 1, wherein the circumferential slot extends around less than approximately 50 percent of the at least one shroud.

5. The system as in claim 1, further comprising a tab connected to the circumferential slot and extending radially outward from the circumferential slot.

6. The system as in claim 5, wherein the tab is substantially straight.

7. The system as in claim 5, wherein the tab is at least partially curved.

8. The system as in claim 1, further comprising a shield circumferentially surrounding the plurality of nozzles, wherein the shield comprises an opening radially aligned with the circumferential slot.

9. A system for conditioning flow through a combustor, comprising:
a. a plurality of nozzles;
b. a shroud circumferentially surrounding at least a portion of each nozzle;
c. a shield circumferentially surrounding the plurality of nozzles; and
d. a flow path through the shield and through at least one shroud.

10. The system as in claim 9, wherein each shroud comprises a bellmouth opening.

11. The system as in claim 9, further comprising a plurality of vanes extending radially inward from the at least one shroud downstream from the flow path through the shield and the at least one shroud.

12. The system as in claim 9, wherein the flow path extends around less than approximately 50 percent of the at least one shroud.

13. The system as in claim 9, wherein the flow path comprises a circumferential slot through the at least one shroud.

14. The system as in claim 13, further comprising a tab connected to the circumferential slot and extending radially outward from the circumferential slot.

15. The system as in claim 14, wherein the tab is substantially straight.

16. The system as in claim 14, wherein the tab is at least partially curved.

17. A system for conditioning flow through a combustor, comprising:
a. a nozzle;
b. a shroud circumferentially surrounding at least a portion of the nozzle, wherein the shroud defines an upstream opening;
c. a plurality of vanes extending radially inward from the shroud; and
d. a circumferential slot extending through the shroud between the upstream opening and the plurality of vanes.

18. The system as in claim 17, wherein the upstream opening comprises a bellmouth shape.

19. The system as in claim 17, wherein the circumferential slot extends around less than approximately 50 percent of the shroud.

20. The system as in claim 17, further comprising a tab connected to the circumferential slot and extending radially outward from the circumferential slot.
